(19) United States
(12) Patent Application Publication
(10) Pub. No.: US 2002/0148137 A1
(43) Pub. Date: Oct. 17, 2002

(54) Paint dryer and paint dryer system

(76) Inventors: Friedhelm Eisenacher, Bad Hersfeld (DE); Dieter Schlag, Fronhausen (DE); Herbert Muller, Wolfersheim (DE)

Correspondence Address: Rocco S. Barrese, Esq., DILWORTH & BARRESE, LLP, 333 Earle Ovington Blvd., Uniondale, NY, 11553, US

(21) Appl. No.: 10/085,220

(22) Filed: Feb. 28, 2002

Related U.S. Application Data
(63) Continuation of application No. PCT/EP00/08455, filed on Aug. 30, 2000.

(30) Foreign Application Priority Data
Aug. 30, 1999 (DE) 199 41 184.0

(51) Int. Cl. F26B 17/00

(52) U.S. Cl. 34/576

(57) ABSTRACT

The inventive paint dryer, comprises a cabin (12) for housing objects (15) that are to be painted and dried. At least one fresh air supply (8) is provided in order to introduce fresh air into an air circulation system pertaining to the dryer (1) resulting in the circulation of said air. At least one pure gas supply line (7) is provided, wherein thermally cleaned and heated waste air is introduced as a pure gas, thereby maintaining the waste gas circulated in the circulation system at the desired temperature in such a way that objects (15) arranged in the cabin (12) can be dried by radiation and/or convection. The pure gas supply line (7) is surrounded by the fresh air supply line (8) at least along a longitudinal pipe segment and at least in said longitudinal pipe section the pure gas supply pipe (7) is constructed in such a way as to allow for the transmission of heat to fresh air flowing into the fresh air supply (8). The invention also relates to a paint dryer unit comprising several paint dryer modules which are positioned one after the other and configured as paint dryers according to the invention.

### FIELD OF THE INVENTION

The invention relates to a paint dryer which is especially suitable for drying vehicle bodies, such as commercial vehicle or automobile bodies. One such paint dryer comprises a booth interior for accomodating painted items to be dried. At least one fresh air conduit is provided for introducing fresh air into a recirculation air system of the dryer. Recirculation air is circulated in the recirculation air system to maintain a desired process temperature in the dryer. In addition, at least one clean gas pipe is provided in which waste air subjected to thermal cleaning and thereby heated is supplied as clean gas with which the waste air circulated in the recirculation air system can be maintained at the desired temperature level so that the items located in the booth interior can be dried by radiation and/or convection.

The invention relates furthermore to a paint drying system composed of a train of paint dryer modules. Each of the paint dryer modules has substantially the same basic configuration but depending on its location in the system is configured as an infeed or outfeed air lock, radiant module, recirculation air module or combination radiant/recirculation air module. This modular concept has the advantage that the individual paint dryers can be fully assembled in fabrication and shipped to the site directly where they merely need to be installed and interconnected, normally by welding.

It is to be noted that transport means are usually provided in paint dryers or paint drying systems with which the individual vehicle bodies are transported to advantage continually through the booth interior of the dryer.

A paint dryer for commercial vehicle or automobile bodies consists as a rule of an air lock at the start and end of the paint dryer, a curing zone and a baking zone. The air locks have the task of minimizing the exchange of air between the booth interior of the paint dryer and the environment and thus to minimize heat losses. Downstream of the infeed air lock the bodies are transported into the curing zone. Since the paint is initially still highly sensitive to strong air movements, mainly radiated heat is generated in the curing zone for drying. This may be done by means of infrared quartz crystal radiators or by radiant pods. Such a pod basically consists of a housing usually made of sheet metal through which a flow of hot air, more particularly also clean gas, is directed. The outer walls of the housing heat up and give off their heat via dark radiation to the booth interior. Downstream of the curing zone the bodies pass through the baking zone. Here they are dried by heat convection with circulating hot recirculation air. The recirculation air is heated in heat exchangers by means of clean gas and set into motion by fans.

Due to the drying process, the solvents of the paint escape and gain access to the dryer. To maintain the concentration of the solvents constantly low a portion of the dryer air is continually exhausted as waste gas and replaced by preheated fresh air. The waste gas is supplied to a thermal reheater (TRH) where the solvent components are reheated in gaining energy and the resulting hot clean gas returned to the paint dryer. Here, it is used for heating the radiant pods and the heat exchangers before being exhausted.

### PRIOR ART

Known from DE 44 36 018 A1 is a paint dryer for a painting system intended more particularly for vehicle bodies. The booth-type paint dryer comprises a booth interior for accomodating painted items to be dried. It is equipped with at least one heating element arranged in the dryer for heating the items to be dried. The at least one heating element can be heated by making use of waste air of the painting system routed through at least one clean gas pipe in being thermal cleaned and thereby heated. To minimize the investment and operating costs the clean gas pipe is installed in the paint dryer and configured to give off heat into the booth interior. In the example embodiment as shown two clean gas pipes are provided arranged in the longitudinal direction of the booth and symmetrical to a vertical longitudinal centerplane of the paint dryer. Provided below the clean gas pipes are two fresh air ducts which are, however, insulated from the clean gas pipes. In this case it is provided for that the clean gas pipes are able to radiate heat at least over a partial circumferential section directly into the booth interior to thus contribute towards drying. For heating the recirculation air circulated in the booth interior it is additionally provided for that the recirculation air is drawn past the clean gas pipes.

Although paint dryers of the aforementioned kind exploit the energy of clean gas, i.e. waste air subjected to thermal cleaning in thereby being heated, heating the fresh air as needed is done in special fresh air units, i.e. in separate heating means serving exclusively this purpose. This approach involves, for one thing, additional costs and, for another, an increased space requirement whilst hampering access to the other ducts, conduits, filters and more particularly to the radiant pods of a paint dryer.

### SUMMARY OF THE INVENTION

The technical problem forming the basis of the invention consists of providing a paint dryer of the aforementioned kind as well as a paint drying system, both of which necessitate fewer units.

This technical problem is solved by a paint dryer having the features as set forth in claim 1 and by a paint drying system having the features of claim 16 respectively. A paint dryer in accordance with the invention thus comprises a booth interior for accomodating painted items to be dried. At least one fresh air conduit is provided with which fresh air can be introduced into a recirculation air system of the dryer in which the recirculation air is circulated. In addition, at least one clean gas pipe is provided in which waste air having been subjected to thermal cleaning and thereby heated is supplied as clean gas with which the recirculation air circulated in the recirculation air system can be maintained at the desired temperature level so that the items located in the booth interior can be dried by radiation and/or convection. Now, the clean gas pipe is surrounded at least sectionwise in length by the fresh air conduit, it being at least in this longitudinal section that the clean gas pipe is configured to give off heat to the fresh air flowing in the fresh air conduit.

A paint drying system in accordance with the invention comprises a train of paint dryer modules, each of which is configured as a paint dryer of the configuration in accordance with the invention. In the paint drying system the at least one clean gas pipe extends over all paint dryer modules. In this arrangement the clean gas pipe is surrounded by the fresh air conduit over a longitudinal section, more particularly a substantially section thereof.

The gist of the invention is to make use of the clean gas pipe itself at least over a partial length section thereof as the preheating source for the fresh air to be heated in thus achieving at least in this section a highly compact configuration since the clean gas pipe runs in the fresh air conduit. This special piping arrangement has the dual function of, for one thing, preheating the fresh air without this requiring a special unit and, for another, reducing the space needed for both lines. In addition, this simplifies the otherwise complicated piping arrangement due to the lack of space in a paint dryer, more particularly in a paint drying system which is prefabricated in individual modules in manufacture.

In one advantage embodiment an infeed and an outfeed air lock are provided including the booth interior inbetween. The clean gas pipe extends between the infeed and outfeed air lock so that means and units to be supplied with clean gas, more particularly the heat exchangers integrated in the recirculation air system, can now be supplied simply and expediently via connectors branching off from the clean gas pipe. In this arrangement the clean gas pipe is, of course, surrounded in accordance with the invention at least sectionwise, preferably however substantially full-length, by the fresh air conduit, as a result of which the fresh air flowing in the fresh air conduit is preheated by the hot clean gas at the advantageously non-insulated pipe section lengths of the clean gas pipe.

One embodiment of a paint dryer in accordance with the invention featuring a highly compact and simple embodiment provides for only a single fresh air supply in the dryer zone located between the infeed and outfeed air lock porting into the fresh air conduit. Furthermore, a fresh air distributor means is provided which directs part of the fresh air supplied via the fresh air supply in the direction of the infeed air lock and part in the direction of the outfeed air lock in thus achieving continual preheating in both directions of the supplied fresh air and the fresh air flowing in the fresh air conduit via a sole central connection.

In some circumstances it may be of advantage to port several fresh air supplies in the dryer zone, located between the infeed and outfeed air lock, into the fresh air conduit. It is then good practice that each fresh air supply is assigned a fresh air distributor means which directs the fresh air supplied by each fresh air supply in the direction of the nearer of the two air locks. It may, however, also be preferred to configure all fresh air distributor means so that the fresh air is directed in solely one direction leading to an air lock in achieving graduated preheating over the full-length of the clean gas pipe.

Distribution means of the aforementioned kind may be, for example, dampers as used in prior art dryers.

In making use of a sole fresh air supply it is particularly preferred to port it into the fresh air conduit roughly midway between the infeed and outfeed air lock.

Further preheating of the fresh air is achieved by directing one or more fresh air supplies also via a partial length section within a waste air conduit for the hot waste air from the dryer. Simply by directing the waste air conduit and fresh air supply in this way enables the fresh air to be heated by approx. 20%. By further directing the clean gas pipe in the fresh air conduit up to the infeed or outfeed air lock further heating by approx. 70% above the original fresh air temperature is achievable.

Advantageously, at each infeed and outfeed air lock one or more heat exchangers are provided in which the fresh air is heated to an even higher temperature level, the heat exchangers being operated by the clean gas. Advantageously, the heat exchangers are of the shell-and-tube type with a tube flow of clean gas surrounded by a shell flow of recirculation air or fresh air.

The aforementioned arrangement in accordance with the invention of the fresh air conduit and clean gas pipe also permits a very simple structural configuration in the paint dryer, it thus being more particularly simple structurally and also in insulation to configure the fresh air conduit as an elongated duct in which the clean gas pipe runs so that over the length of the fresh air conduit preheating of the fresh air flowing therein is achieved by the hot clean gas flowing in the clean gas pipe. This elongated duct can be closed off to advantage over its length extent by at least one removable cover part and is insulated full-length.

Since the fresh air conduit and the clean gas pipe extending therein are arranged optimally on the upper side, underside or sides of the paint dryer it is now extremly simple by means of the cover part to gain access to the fresh air conduit and adjoining dryer components. When arranged above the booth interior, lifting it via a lifting means provided for this purpose is very simple, for example by means of a crane, such as for example a gantry crane, or by means of a winch. This very simple structual configuration overcomes the problem of very difficult access to the various units of the paint dryer in prior art for cleaning purposes, this now being possible with no major complications. This advantage exists irrespective of whether the fresh air conduit and the clean gas pipe are arranged above, below or to the side of the booth interior.

The fresh air is drawn in to advantage by fans arranged in the infeed and outfeed air locks. These fans are part of the recirculation air system and simultaneously serve to circulate the recirculation air in these zones in thus having a dual function: for one thing, circulating the recirculation air in the infeed and outfeed duct, for another, drawing in the fresh air from the fresh air supply to the infeed and outfeed air locks. The fresh air is basically heated to roughly the process temperature, this temperature amounting to approx. 135° C. for top-coat dryers, approx. 165° C. for primer, i.e. prime-coat dryers and approx. 185° C. for dryers for items coated by catayltic dip coating. The process temperature for curing the underseal is approx. 110° C. The fresh air as preheated in the aforementioned way and the fresh air heated in conclusion to the cited processing temperatures is mixed with recirculation air by circulation in the booth interior.

In the region of the infeed or outfeed air lock the temperature of the fresh air thus already amounts to approx. 120° C. By the fresh air conduit with this heated fresh air directly contacting the roof of the booth interior in the infeed and outfeed air lock zone a so-called “hot roof” is achieved which is extremely of advantage as regards condensation problems. This “hot roof” prevents condensation droplets forming at the otherwise colder roof element in thus preventing water droplets from forming which could otherwise drip down on to the items being transported into and out of the dryer. It is especially in the infeed air lock zone that this is of great advantage and can be furthermore enhanced by special means, it thus being conceived in this respect, for example, to direct the fresh air in the region of the infeed air lock over the full width of the booth interior so that the complete width of the roof is heated over a certain length.

It is to be noted furthermore in this case that a paint dryer in accordance with the invention and also a paint drying system in accordance with the invention can be put to use for all known types thereof. Thus a dryer or system in accordance with the invention may feature a floor which is level throughout in the booth interior, although it is just as possible to configure means in accordance with the invention as a so-called A-dryer, meaning that a lift is provided at the start and end of a paint dryer or paint drying system for lifting the bodies to booth level. The booth interior in which actual drying takes place is thus elevated relative to the start and end. This type prevents, in addition to the other means, escape of hot air from the booth interior. The same applies to a so-called “camel back” furnace. In this type the actual dryer booth is likewise elevated, but slant lifts are provided at the start and end for the bodies.

### BRIEF DESCRIPTION OF THE DRAWINGS

Several example embodiments of the invention will now be detailled for further explanation and a better understanding with reference to the attached drawings in which

FIG. 1 is a cross-sectional view of paint dryer module for a paint drying system in accordance with the invention, configured as an infeed or outfeed air lock, as taken along the line I-I as shown in FIG. 2.

FIG. 2 is a vertical longitudinal section of the paint dryer module as shown in FIG. 1,

FIG. 3 is a cross-section through the paint dryer module as taken along the line III-III as shown in FIG. 2,

FIG. 4 is a horizontal longitudinal section through the paint dryer module as shown in FIG. 2 as taken along the line IV-IV,

FIG. 5 is a cross-section through a radiant recirculation air paint dryer module for a paint drying system in accordance with the invention as taken along the line V-V as shown in FIG. 6,

FIG. 6 is a vertical longitudinal section through the paint dryer module as shown in FIG. 5,

FIG. 7 is a cross-section through the paint dryer module as taken along the line VII-VII as shown in FIG. 6,

FIG. 8 is a horizontal longitudinal section through the paint dryer module as taken along the line VIII-VIII as shown in FIG. 6,

FIG. 9 is a cross-section through a recirculation air paint dryer module for a paint drying system in accordance with the invention as taken along the line IX-IX as shown in FIG. 10,

FIG. 10 is a vertical longitudinal section as taken along the line X-X as shown in FIG. 11,

FIG. 11 is a horizontal longitudinal section as taken along the line XI-XI as shown in FIG. 10,

FIGS. 12-15 are illustrations of a paint drying system composed of various paint dryer modules from an infeed air lock to an outfeed air lock; the upper row of the FIGS. 12 to 15 featuring a vertical longitudinal section as taken along the line A-A in the lower row of the Figs. .

### DETAILLED DESCRIPTION OF THE INVENTION

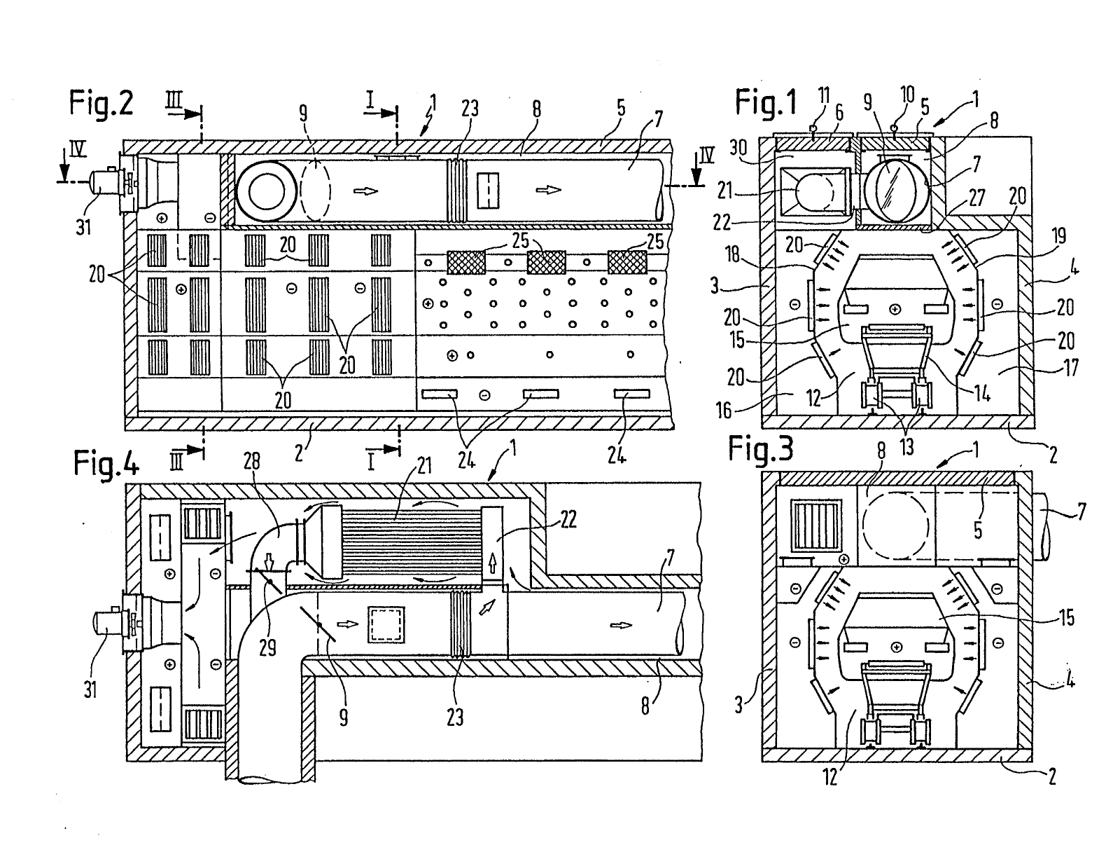

Referring now to FIG. 1 there is illustrated an example of the basic configuration of a paint dryer 1 in accordance with the invention. This cross-section as shown in FIG. 1 shows a paint dryer configured as an infeed and outfeed air lock 1 respectively. The air lock 1 comprises a floor 2 and sidewalls 3, 4. Connected to the floor are means 13 for guiding skids 14 so that vehicle bodies 15 secured thereto can be transported along a booth interior 12. The tunnel-type booth interior 12 is formed by the booth sidewalls 18, 19, the floor 2 as well as by a booth roof 27.

In the cross-sectional view as shown in FIG. 1 the infeed and outfeed air lock 1 respectively are equipped with inflow openings 20 through which the heated recirculation air flows into the booth interior 12.

In the roof zone of the paint dryer 1 a fresh air conduit duct 8 runs midway as viewed cross-sectionally, this duct being closed off at the top by a removable cover part 5. Provided on the removable cover part 5 are one or more lugs 10 for hook-attaching a lifting means. The fresh air conduit 8 is insulated on all sides from the exterior. However, in the cross-sectional view as shown in FIG. 1, since this illustrates the infeed zone, the underside 27 is not insulated so that this roof 27 is heated by hot clean gas flowing in a clean gas pipe 7 running along the fresh air conduit 8 in thus preventing water droplets forming at the side of the roof 27 facing the booth interior 12.

Referring now to FIG. 4 there is illustrated in particular, branching from the clean gas pipe 7, a heat exchanger connector 22 which ends in a shell-and-tube heat exchanger 21. From the heat exchanger 21 the clean gas directed through the heat exchanger 21 is guided via an outlet stub 28 to recirculation air side ducts 16, 18 via which it then flows into the booth interior. As evident from FIG. 4 a portion of the clean gas thus flows from the clean gas pipe 7 through the connector 22 into the the individual tubes of the shell-and-tube heat exchanger 21 before then being directed, collected via the outlet stub 28, into the side ducts 16, 17. The portion flowing into the side ducts 16, 17 can be controlled via a damper 29. In all, the flow of clean gas in the pipe 7 can be controlled via the damper 9 as shown in FIG. 4.

As evident from FIG. 4 fresh air flows from the fresh air conduit in counterflow to the clean gas in the clean gas pipe 7 about the latter. In the infeed and outfeed air lock 1 respectively the already preheated fresh air is introduced into the roof cavity 30 in which the shell-and-tube heat exchanger 21 resides. Due to the hot clean gas guided in the tubes of the a shell-and-tube heat exchanger 21 the preheated fresh air is further heated to then flow via openings and filters into the prechamber areas as evident from FIGS. 2 and 4 or from FIGS. 1 and 3. The roof cavity 30 is in turn closed off at the top by a removable cover part 6. Here again for lifting the cover part 6 one or more lugs 11 for lifting means are provided. For removing the heat exchanger the cover part 6 is lifted by means of a lifting means 11. Since the heat exchanger 21 is flanged to the connectors 23, 28 merely by a few bolts, this is easy to remove.

For circulating the recirculation air in the infeed or outfeed air lock 1 a fan 21 is provided which also ensures that the fresh air in the fresh air conduit 8 is drawn into the infeed or outfeed air lock end from a fresh air supply, as detained later, midway in a paint drying system composed of several modules. As evident from FIG. 2 in particular the infeed or outfeed air lock 1 is divided into several segments in which the heated recirculation air is introduced into/exhausted from the booth interior at various pressures. Thus, the segment nearest to the infeed side receives recirculation air at an overpressure so that no outside air can be drawn into the paint drying system. The further downstream segments receive a vacuum or overpressure. Thus, for example, the recirculation air introduced into the third segment (as viewed from the left) at the top receives overpressure, whilst at the bottom the recirculation air is exhausted from the booth interior through openings 24.

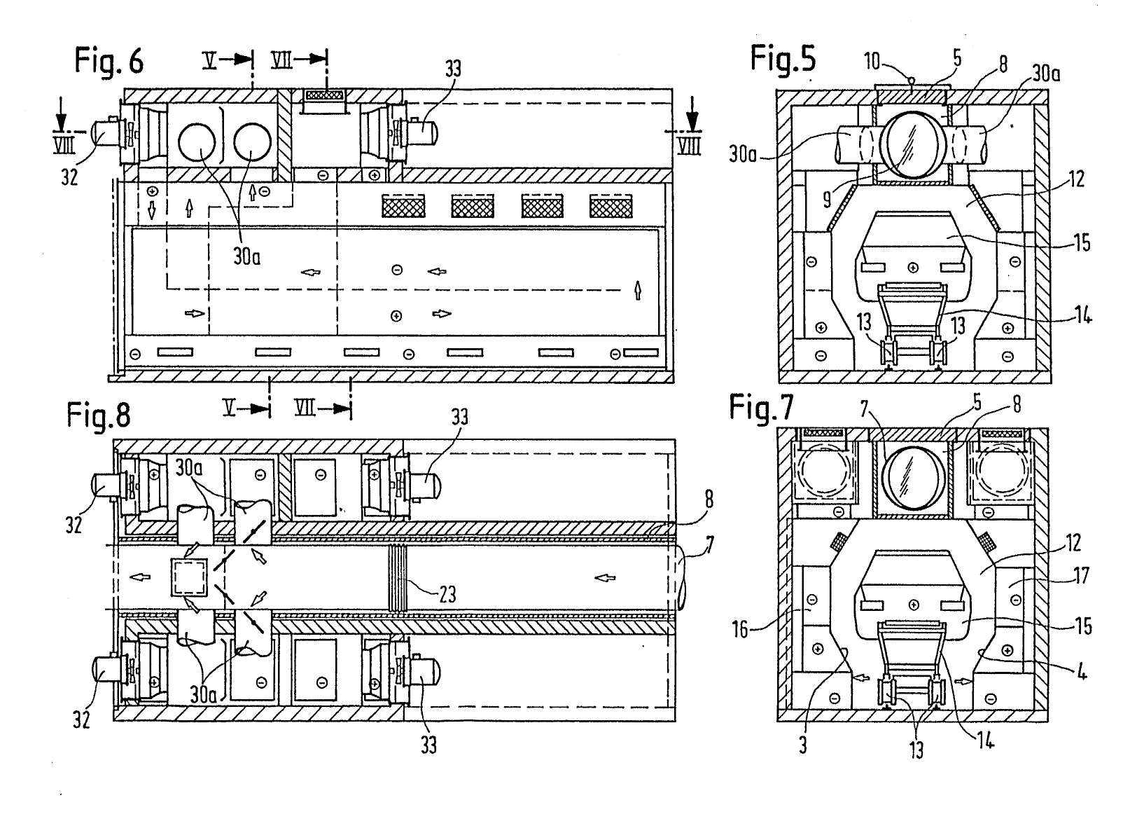

Referring now to FIGS. 5-8 there are illustrated various section views of a paint dryer comprising a radiant and recirculation air zone. As evident from the cross-sectional view as shown in FIG. 5 the clean gas pipe 7—likewise as in turn for the infeed or outfeed air lock as shown in FIGS. 1-4—is run along the the tunnel-shaped booth interior 12 and surrounded by the fresh air conduit 8. In turn, a removable cover part 5 is provided to ensure facilitated access to the fresh air conduit and also to the clean gas pipe 7. As evident from the section view as shown in FIG. 5 two connectors 30a each branch off to the left and right serving supply from the recirculation air side ducts 16, 17. For circulating the clean gas serving as the hot recirculation air, fans 32 fitted to one side are provided, further fans 33 serving to circulate the recirculation air in the recirculation air zone of the paint dryer as shown. It is also evident that the portion as shown in FIG. 5 is configured as a radiant zone, whereas that as shown in FIG. 7 is a recirculation air zone. It is particularly from FIG. 6 that the run of the flows in the side ducts 16, 17 is clearly evident.

As particularly evident from FIG. 8 the clean gas pipe 7 is divided into several portions interconnected via an adapter 23 to compensate the various thermal expansions over the length of the pipe 7.

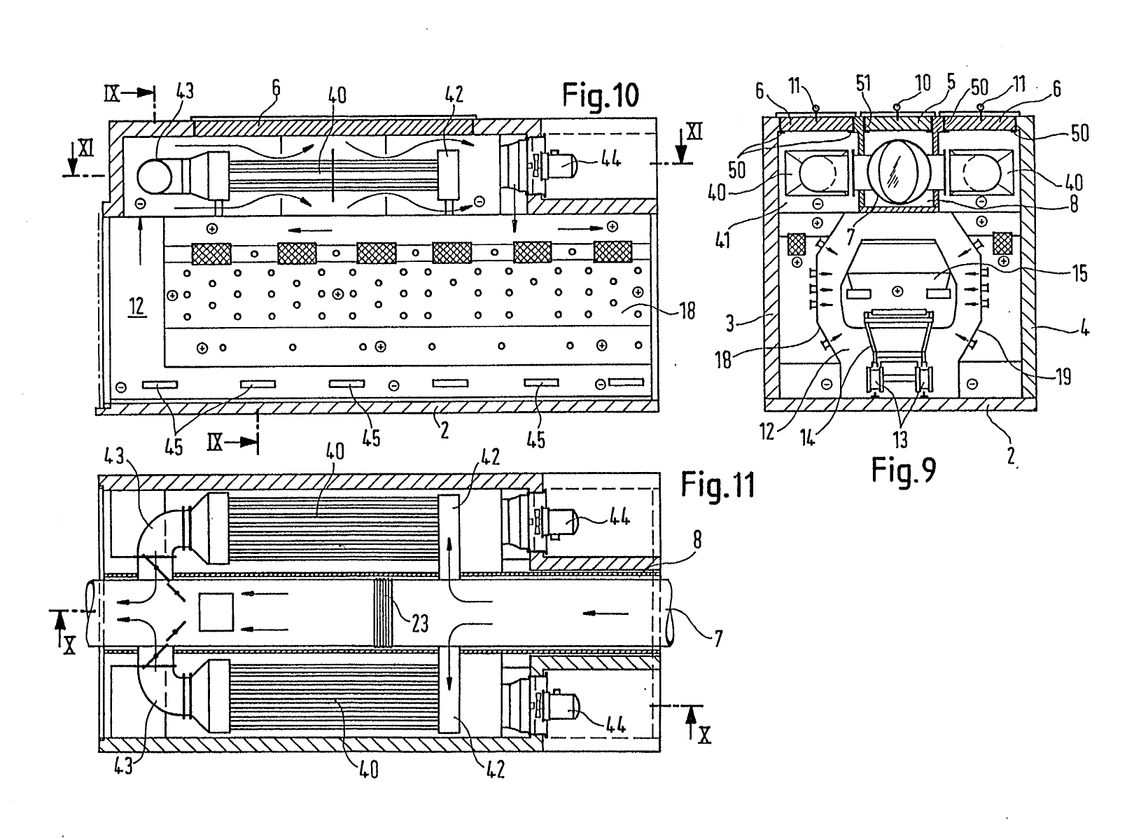

Referring now to FIGS. 9-11 in conclusion there are illustrated various section views of a paint dryer module comprising only a single recirculation air zone. The same as in the aforementioned modules the clean gas pipe 7 in the fresh air conduit 8 is arranged midway in the roof portion as viewed cross-sectionally. In this module a shell-and-tube heat exchanger 40 is arranged to the right and left of the fresh air conduit 8 in a housing cavity 41. These shell-and-tube heat exchangers 40 are operated with the clean gas from the clean gas pipe 7. The clean gas directed through the tubes of the shell-and-tube heat exchanger 40 is then collected in clean gas return conduits 43 and returned to the clean gas pipe. Here again dampers are provided for flow control. The same as in the embodiment as shown in FIGS. 1-4 here too the heat exchangers 40 have facilitated access by removable cover parts 6.

Referring now to FIG. 10 there is illustrated how the shell-and-tube heat exchangers 40 are surrounded by a flow of recirculation air, fans 44 serving to circulate the recirculation air, one each being provided for each shell-and-tube heat exchanger 40 in thus directing the recirculation air in the module via the shell-and-tube heat exchangers 40 for heating thereof. The heated fresh air is then introduced into the side ducts 16, 17 where it is directed through openings into the booth interior 12. In the lower region the recirculation air is then exhausted from the booth interior 12 through openings 45 and redirected into the shell-and-tube heat exchanger.

As evident from FIG. 9 in particular, gaskets 50 are provided for sealing the cover parts 5, 6 so that the recirculation air housing cavities 41 as well as the fresh air conduit 8 are hermetically sealed.

Common to all Figs. is that overpressure zones of the recirculation air are identified by an encircled “+” vacuum zones by an encircled “−”.

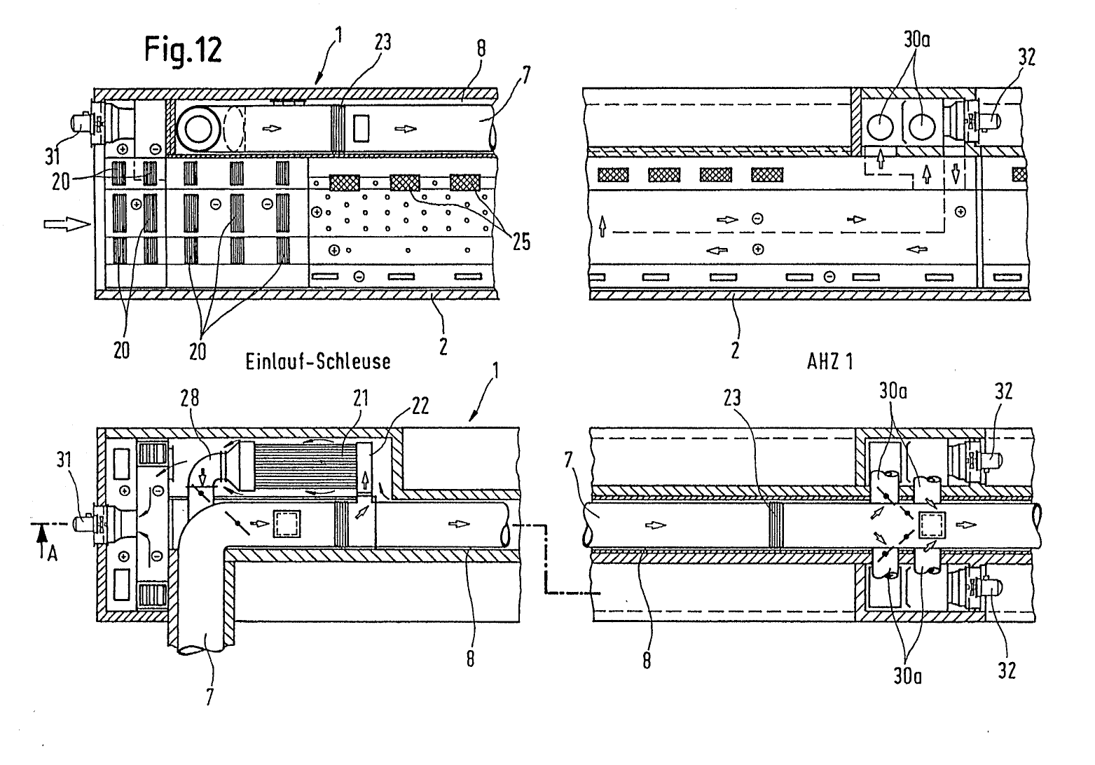

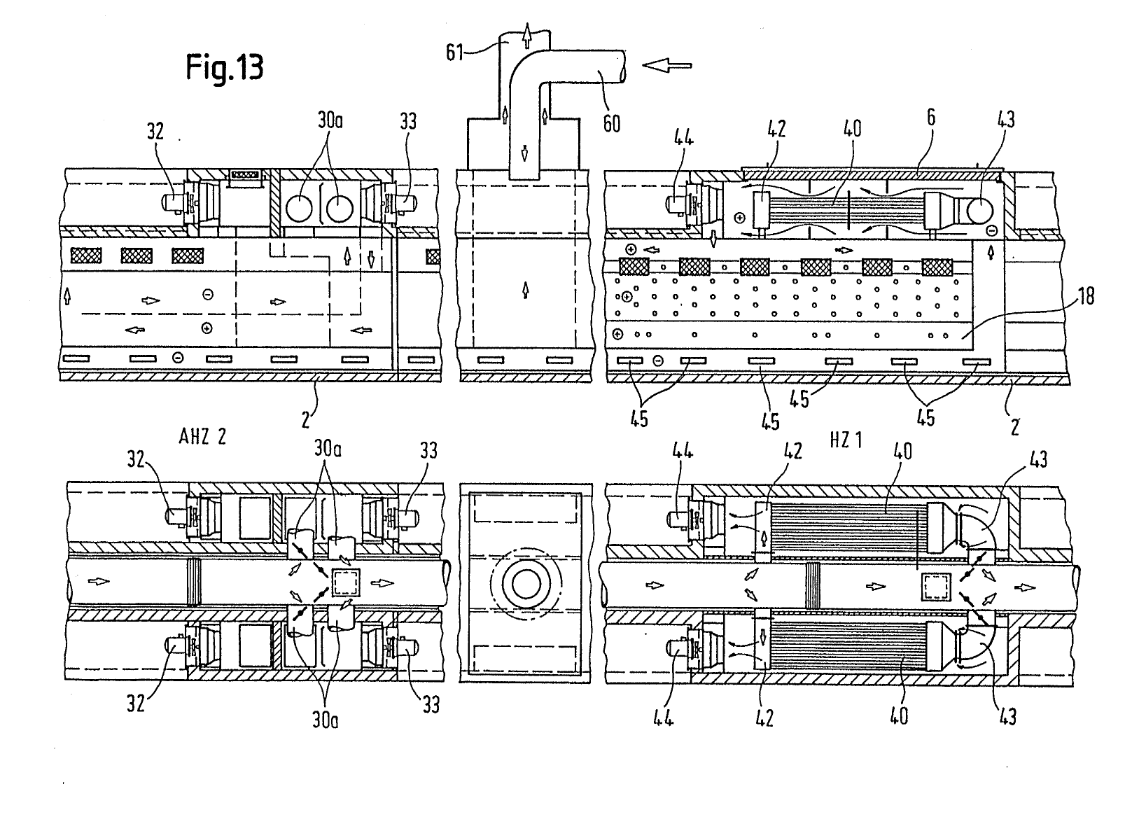

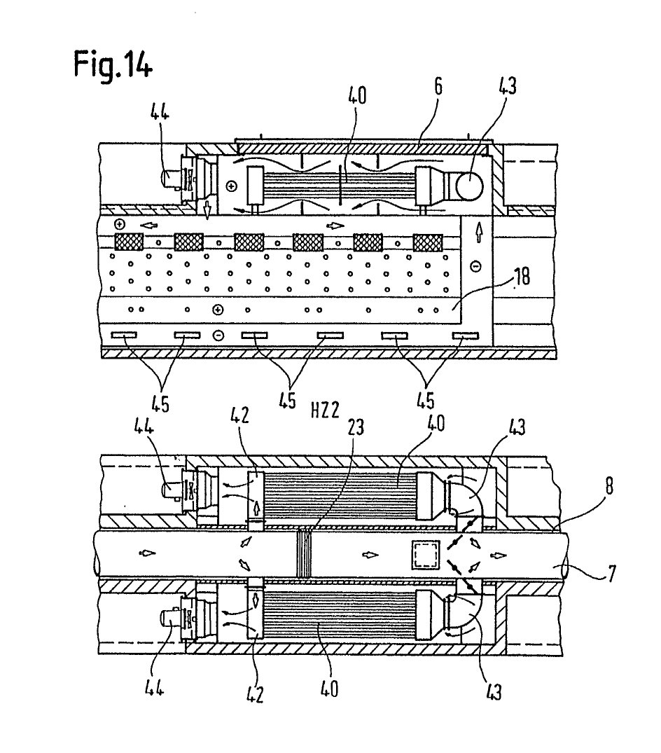

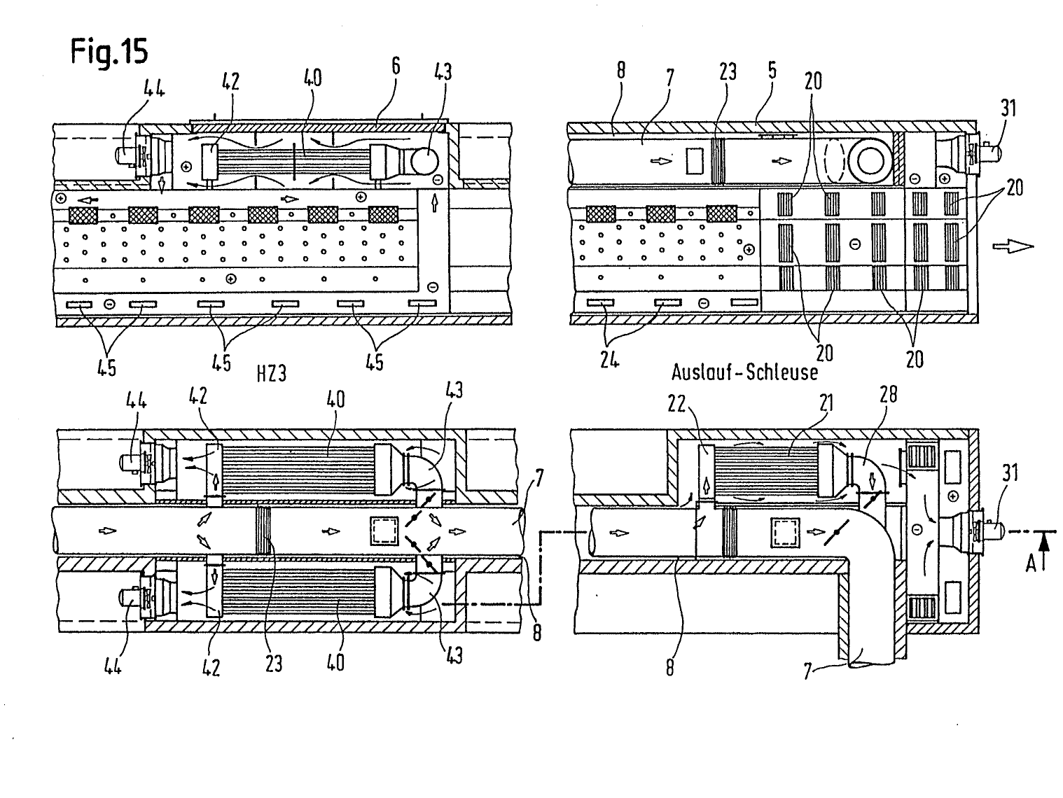

Referring now to FIGS. 12-15 there is illustrated a paint drying system comprising the various modules as shown in FIGS. 1-11. The train of the FIGS. 12-15 results in a system suitable for drying painted vehicle bodies. The vehicle bodies are introduced on the left as shown in FIG. 12 through an infeed air lock to pass through the tunnel-shaped booth interior. Adjoining the infeed air lock is a curing zone 1 (AHZ 1) in which the vehicle bodies are preheated. Most of the drying is done, however, via radiation. Adjoining the first curing zone is a second curing zone (AHZ 2). This curing zone is configured substantially the same as the first curing zone. As evident from FIG. 13 the second curing zone is followed by a baking zone 1 (HZ 1). Provided between the first curing zone and curing zone 2 is a fresh air supply 60 porting into the fresh air conduit 8. The fresh air supply 60 is surrounded by a waste air conduit 61 over a certain length thereof. In the waste air conduit 61 recirculation air contaminated with solvents is exhausted from the booth interior as waste air and supplied to a thermal reheater. Since the waste air contaminated with solvents is hot, it is here that due to the special arrangement of the fresh air supply 60 and waste air conduit 61 that the fresh air thus receives a first preheating in the fresh air supply 60. As already mentioned, the already preheated fresh air is then further preheated by the its flow in the fresh air conduit being contrary to that of the hot clean gas in the clean gas pipe 7.

In the baking zone 1 the vehicle bodies passing through the booth interior receive further drying by convection. The first baking zone is followed by further baking zones 2 and 3 (HZ 2 and HZ 3). The system then ends in an outfeed air lock from which the dried vehicle bodies are transported. As regards the configuration of the infeed air lock, AHZ 1, AHZ 2, HZ 1-HZ 3 and the outfeed air lock reference is made to FIGS. 1-11. The curing zone 1 and curing zone 2 are configured as shown in FIGS. 5-8, the baking zones 1-3 as shown in FIGS. 9-11.

1. A paint dryer, more particularly for drying vehicle bodies, including
a booth interior (12) for accomodating painted items (15) to be dried,
at least one fresh air conduit (8) with which fresh air can be introduced into a recirculation air system of the dryer (1) in which recirculation air is circulated, and
at least one clean gas pipe (7) in which waste air subjected to a thermal cleaning and is thereby heated is directed as clean gas with which the recirculation air circulated in said recirculation air system can be maintained at the desired temperature level, so that the items (15) located in said booth interior (12) can be dried by radiation and/or convection,
whereby
said clean gas pipe (7) is surrounded at least over a section length thereof by said fresh air conduit (8) and
at least in said section length thereof said clean gas pipe (7) is configured to give off heat to the fresh air flowing in said fresh air conduit (8).

2. The paint dryer as set forth in claim 1 characterized in that
an infeed and an outfeed air lock is provided and said booth interior (12) extends full-length therein,
said clean gas pipe (7) extends between said infeed and said outfeed air lock.

3. The paint dryer as set forth in claim 2, characterized in that
a sole fresh air supply (60) in the portion located between said infeed and said outfeed air lock ports into said fresh air conduit (8) and
a fresh air distributor means is provided which directs part of said fresh air supplied by said fresh air conduit in the direction of said infeed air lock and part in the direction of said outfeed air lock.

4. The paint dryer as set forth in claim 2, characterized in that
several fresh air supplies (60) in the portion located between said infeed and said outfeed air lock port into said fresh air conduit (8) and
each fresh air supply (60) is assigned a fresh air distributor means which directs the fresh air supplied by each fresh air supply in the direction of the nearer air lock.

5. The paint dryer as set forth in claim 3 or 4, characterized in that said at least one fresh air supply (60) is guided at least one over a partial section length within a waste air conduit (61).

6. The paint dryer as set forth in claims 1, 3 or 4, characterized in that
said fresh air conduit (8) is configured as an elongated duct in which said clean gas pipe (7) runs, and
said duct can be closed off over its longitudinal extent by at least one removable cover part (5).

7. The paint dryer as set forth in claim 6, characterized in that
said fresh air conduit (8) has a substantially U-shaped cross-section and
at least one removable cover part (5) closes off the open duct side.

8. The paint dryer as set forth in any of the claims 1-7, characterized in that said at least one fresh air conduit (8) and said at least one clean gas pipe (7) are arranged above said booth interior (12).

9. The paint dryer as set forth in any of the claims 1-7, characterized in that said at least one fresh air conduit (8) and said at least one clean gas pipe (7) are arranged to the side of said booth interior (12).

10. The paint dryer as set forth in any of the claims 1-7, characterized in that said at least one fresh air conduit (8) and said at least one clean gas pipe (7) are arranged below said booth interior (12).

11. The paint dryer as set forth in any of the preceding claims, characterized in that
at least one heat exchanger (21, 40) is provided connected, for one thing, to said clean gas pipe (7), for another, to said recirculation air system,
said heat exchanger (21, 40) is accomodated in a housing cavity (30, 41) and
said housing cavity (30, 41) is connected to said recirculation air system so that said heat exchanger (21, 40) accomodated therein is surrounded by the flow of recirculation air circulated in said recirculation air system and is heated by the clean gas flowing in said clean gas pipe (7),
said housing cavity (30, 41) is accessible through a removable housing cover (6).

12. The paint dryer as set forth in claim 11, characterized in that said at least one heat exchanger (21, 40) is arranged above, to the side or below said booth interior (12) and said housing cover (6) is removable upwards.

13. The paint dryer as set forth in claim 6, 7 or 11, characterized in that said cover part (5) of said fresh air conduit (8) and/or said housing cover (6) of said housing cavity (30, 41) are removable by a lifting means.

14. The paint dryer as set forth in claim 6, 7 or 11, characterized in that said cover part (5) of said fresh air conduit (8) and/or said housing cover (6) of said housing cavity (30, 41) are configured in one or several parts.

15. The paint dryer as set forth in claim 11, characterized in that
said heat exchanger (21, 40) is removably flanged to said paint dryer (1) and
said recirculation air cavity (30, 41) adjoining said heat exchanger (21, 40) formed by an outer wall (3, 4) of said paint dryer and a booth wall (18, 19) adjoining said booth interior (12) is thereby accessible.

16. A paint drying system comprising
a train of paint dryer modules each configured as a paint dryer as set forth in any of the claims 1-15,
in which said at least one clean gas pipe (7) extends over all paint dryer modules and said clean gas pipe (7) is surrounded over a substantially section length thereof by said fresh air conduit (8).

17. The paint drying system as set forth in claim 16, characterized in that
at least one paint dryer is configured as a radiant dryer and
at least one paint dryer is configured as a convection dryer.

18. The paint drying system as set forth in claim 16 or 17, characterized in that
an infeed and an outfeed air lock is provided enclosing between them said complete booth interior (12) formed by said train of all paint dryer modules, and
both said infeed and said outfeed air lock is heated.

19. The paint drying system as set forth in claim 18, characterized in that
each infeed and each outfeed air lock is equipped with at least one heat exchanger (21),
each heat exchanger (21) is connected to said clean gas pipe (7) and
each infeed and each outfeed air lock is heated via its own recirculation air system by recirculation air heated in each heat exchanger (21).

20. The paint drying system as set forth in claim 18, characterized in that said clean gas at said infeed air lock is fed into said clean gas pipe (7) to flow in the direction of said outfeed air lock where it is branched off.
